(19) United States
(12) Patent Application Publication
(10) Pub. No.: US 2007/0171833 A1
(43) Pub. Date: Jul. 26, 2007

(54) Socket for use in a networked based computing system having primary and secondary routing layers

(76) Inventors: Sukhbinder Singh, Bangalore (IN); Anil K. Jonnalagadda, Bangalore (IN); Uday Joshi, Bangalore (IN); Tessil Thomas, Bangalore (IN)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/284,488

(22) Filed: Nov. 21, 2005

(51) Int. Cl. H04L 12/26; H04L 12/56

(52) U.S. Cl. 370/241; 370/389

(57) ABSTRACT

A method to be executed within a computing system having a network that couples a processor to a memory controller is described. The method involves receiving a packet and then characterizing the packet as being of a type selected from the group consisting of: i) a debug packet; ii) a system maintenance packet; and, iii) a packet having a destination identifier or connection identifier for which a primary routing table has no entry. The method also involves, because the packet is of the type, using a secondary routing table to identify at least one output port upon which the packet is to be transmitted.

### FIELD OF INVENTION

The field of invention relates to the computer sciences, generally, and, more specifically, to a socket having both primary and secondary routing layers.

### BACKGROUND

Computing systems have traditionally been designed with a “front-side bus” between its processor and it memory controller. High end computing systems typically include more than one processor so as to effectively increase the processing power of the computing system as a whole. Unfortunately, in computing systems where a single front side bus connects multiple processors and a memory controller together, if two components that are connected to the bus transfer data/instructions between one another, then, all the other components that are connected to the bus must be “quiet” so as to not interfere with the transfer.

For instance, if four processors and a memory controller are connected to the same front-side bus, and, if a first processor transfers data or instructions to a second processor on the bus, then, the other two processors and the memory controller are forbidden from engaging in any kind of transfer on the bus. Bus structures also tend to have high capacitive loading which limits the maximum speed at which such transfers can be made. For these reasons, a front side bus tends to act as a bottleneck within various computing systems and in multi-processor computing systems in particular.

In recent years computing system designers have begun to embrace the notion of replacing the front side bus with a network. FIG. 1 shows an approach where the front side bus is essentially replaced with a network 104a having point-to-point links between each one of processors 101_1 through 101_N and memory controller 102. The presence of the network 104a permits simultaneous data/instruction exchanges between different pairs of communicating components that are coupled to the network 104a. For example, processor 101_1 and memory controller 102 could be involved in a data/instruction transfer over a same time period in which processor 101_3 and processor 101_4 are involved in a data/instruction transfer.

Computing systems that embrace a network in lieu of a front side bus may extend the network to include other regions of the computing system 104b such as one or more point-to-point links between the memory controller 102 and any of the computing system's I/O devices (e.g., network interface, hard-disk file, etc.).

### BRIEF DESCRIPTION OF THE DRAWINGS

The present invention is illustrated by way of example and not limitation in the figures of the accompanying drawings, in which like references indicate similar elements and in which:

FIG. 1 (prior art) shows a computing system with a network that couples a processor to a memory controller;

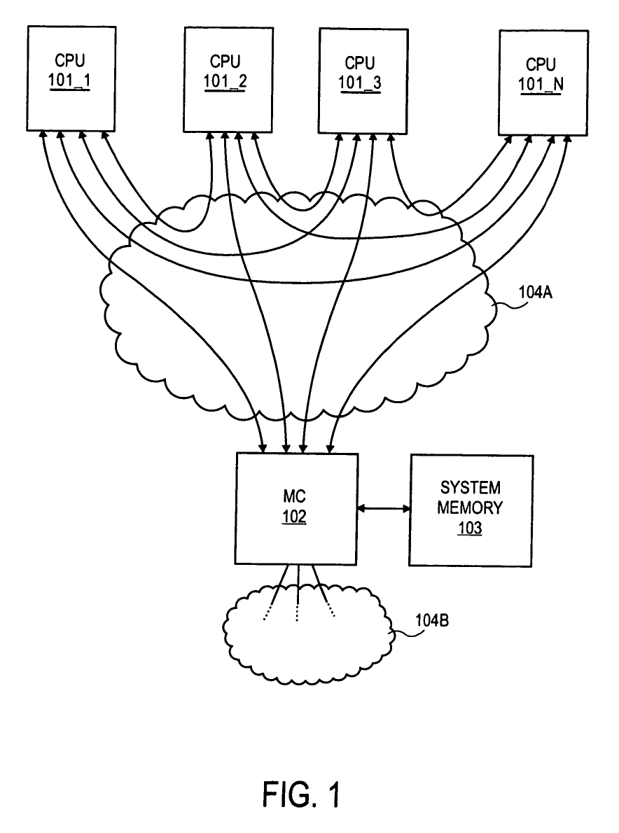

FIG. 2 shows a computing system having sockets interconnected by a network;

FIG. 3 shows an improved socket architecture;

FIG. 4 shows a design for the secondary routing layer circuitry of FIG. 3.

### DETAILED DESCRIPTION

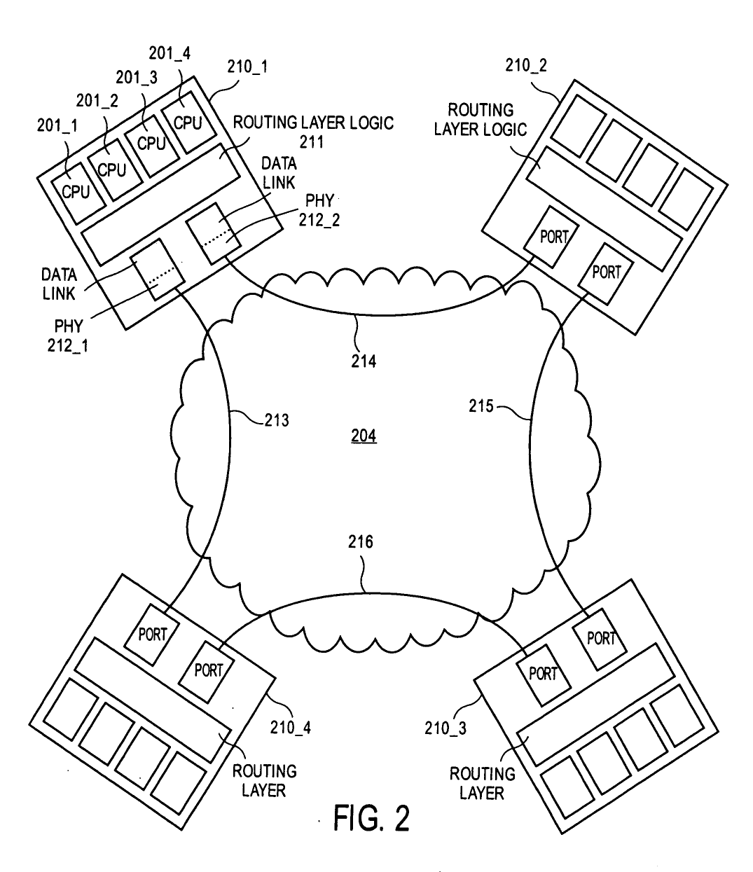

FIG. 2 shows a more detailed depiction of a multi-processor computing system that embraces the placement of a network, rather than a bus, between components within the computing system. The components 210_1 through 210_4 that are coupled to the network 204 are referred to as “sockets” because they can be viewed as being plugged into the computing system's network 204. One of these sockets, socket 210_1, is depicted in detail.

According to the depiction observed in FIG. 2, socket 210_1 is coupled to network 204 through two bi-directional point-to-point links 213, 214. In an implementation, each bi-directional point-to-point link is made from a pair of uni-directional point-to-point links that transmit information in opposite directions. For instance, bi-directional point-to-point link 214 is made of a first uni-directional point-to-point link (e.g., a copper transmission line) whose direction of information flow is from socket 210_1 to socket 210_2 and a second uni-directional point-to-point link whose direction of information flow is from socket 210_2 to socket 210_1.

Because two bi-directional links 213, 214 are coupled to socket 210_1, socket 210_1 includes two separate regions of data link layer and physical layer circuitry 212_1, 212_2. That is, circuitry region 212_1 corresponds to a region of data link layer and physical layer circuitry that services bi-directional link 213; and, circuitry region 212_2 corresponds to a region of data link layer and physical layer circuitry that services bi-directional link 213. As is understood in the art, the physical layer of a network typically forms parallel-to-serial conversion, encoding and transmission functions in the outbound direction and, reception, decoding and serial-to-parallel conversion in the inbound direction.

That data link layer of a network is typically used to ensure the integrity of information being transmitted between points over a point-to-point link (e.g., with CRC code generation on the transmit side and CRC code checking on the receive side). Data link layer circuitry typically includes logic circuitry while physical layer circuitry may include a mixture of digital and mixed-signal (and/or analog) circuitry. Note that the combination of data-link layer and physical layer circuitry may be referred to as a “port” or Media Access Control (MAC) layer. Thus circuitry region 212_1 may be referred to as a first port or MAC layer region circuitry region 212_2 may be referred to as a second port or MAC layer circuitry region 212_1.

Socket 210_1 also includes a region of routing layer circuitry 211. The routing layer of a network is typically responsible for forwarding an inbound packet toward its proper destination amongst a plurality of possible direction choices. For example, if socket 210_2 transmits a packet along link 214 that is destined for socket 210_4, the routing layer 211 of socket 210_1 will receive the packet from port 212_2 and determine that the packet should be forwarded to port 212_1 as an outbound packet (so that it can be transmitted to socket 210_4 along link 213).

By contrast, if socket 210_2 transmits a packet along link 214 that is destined for processor 201_1 within socket 210_1, the routing layer 211 of socket 210_1 will receive the packet from port 212_2 and determine that the packet should be forwarded to processor 201_1. Typically, the routing layer undertakes some analysis of header information within an inbound packet (e.g., destination node ID, connection ID) to “look up” in which direction the packet should be forwarded. Routing layer circuitry 211 is typically implemented with logic circuitry and memory circuitry (the memory circuitry being used to implement a “look up table”).

The particular socket 210_1 depicted in detail in FIG. 2 contains four processors 201_1 through 201_4. Here, the term processor, processing core and the like may be construed to mean logic circuitry designed to execute program code instructions. Each processor may be integrated on the same semiconductor chip with other processor(s) and/or other circuitry regions (e.g., the routing layer circuitry region and/or one or more port circuitry region). It should be understood that more than two ports/bi-directional links may be instantiated per socket. Also, the computing system components within a socket that are “serviced by” the socket's underlying routing and MAC layer(s) may include a component other than a processor such as a memory controller or I/O hub.

A problem in link based computing systems involves the ease at which they can be debugged. Whereas implementation of a bus permits “all” data/instruction transfers between components connected to the bus to be easily monitored (because transfers can only happen “one-at-a-time” and only a single probe fixture needs to be attached to the bus), by contrast, monitoring data/instruction transfers between components connected through a network is much more difficult because the transfers may be conducted in parallel (i.e., in overlapping time periods) and at physically different locations (e.g., different point-to-point links).

According to one approach, debugging equipment is expected to be attached to various point-to-point links within the computing system. For instance, in order to fully monitor the data/instruction transferring activity between the sockets 210_1 through 210_4 of FIG. 2, a separate probe fixture would be attached to each of links 213 through 216. Each of the link probe fixtures would then couple to, for instance, a logic analyzer system that monitors the various transfers and other transactions taking placed within the computing system network 204.

Moreover, in order to support debugging efforts, a socket may be designed to include debug and/or system maintenance logic circuitry for generating/comprehending “special” debug and/or system maintenance packets. These special types of packets may include, for instance, an “event” or “trigger” debug packet that signifies a “looked-for” event has occurred in the socket that sends the event/trigger packet (e.g., a read or write to a certain memory address), and, a “software state injection” debug packet that includes software state information that exists within the socket that sends the software state injection packet. According to a further implementation, an event/trigger packet is sent by a socket in response to its detection of the looked for event/trigger, and, a software state injection packet is sent by a socket opportunistically (i.e., when the link it is to be sent on is idle). A trigger is a type of event that, typically, causes operations within the computing system to begin to be recorded so that they can be studied later on. A system maintenance packet is usually used to report errors or faults, or, implement a fix thereto.

According to one implementation, because a debug and/or system maintenance packet is expected to be “sensed” be a probe that is attached to the link upon which it was first placed by the socket that generated it, the routing layer within the various sockets of the computing system do not maintain any comprehension of debug and/or system maintenance packets. As such, debug packets are only comprehended by a socket's MAC layer circuitry regions. Because the routing layer does not comprehend the existence of the debug packets, debug packets cannot be sent from one socket to another socket if the pair of sockets are not directly connected together by a link.

Furthermore, it may be necessary in some debugging instances to use a network that is only partially configured. For instance, the network arrangement of FIG. 2 may be viewed as a debugging situation where the routing layer of each socket is essentially “incomplete” such that it does not comprehend any pathway: 1) from socket 210_1 to socket 210_4 (or from socket 210_4 to socket 210_1); and/or, 2) from socket 210_2 to socket 210_3 (or from socket 210_3 to socket 210_2). In this case, it would be impossible to direct any packet from socket 210_1 to socket 210_4 (and/or socket 210_4 to socket 210_1), and/or from socket 210_2 and socket 210_3 (and/or socket 210_3 and socket 210_2) because the routing layer circuitry, being only partially configured, does not comprehend these routing paths.

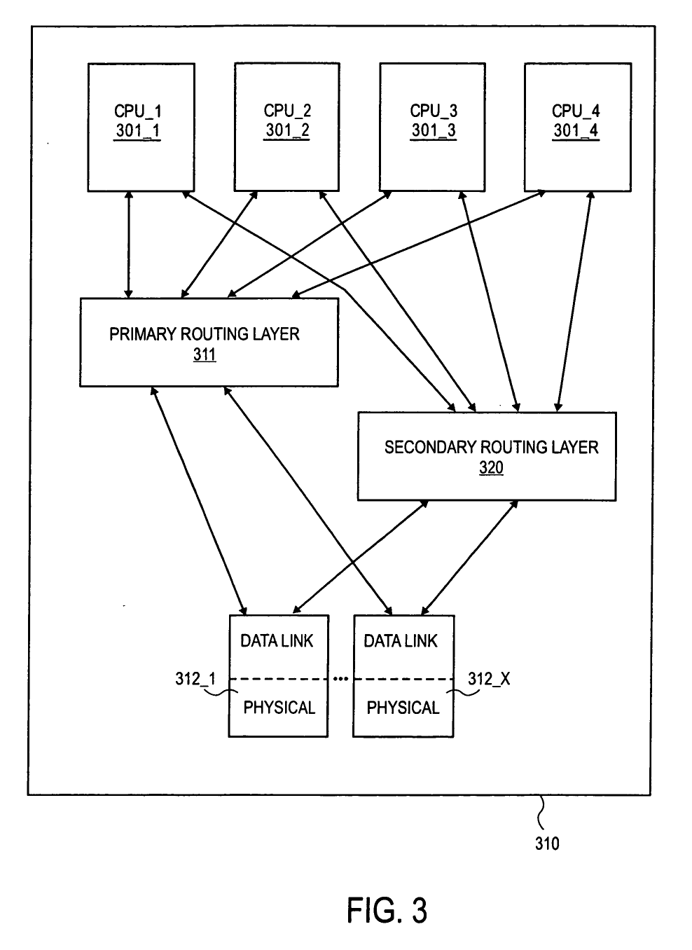

Thus, in at least two instances, the routing layer 211 can be seen as impeding a robust debugging environment (i.e., debug and/or system maintenance packets cannot be routed; and, certain desirable routing paths may not exist). FIG. 3 shows an improved socket architecture 310 that incorporates circuitry 320 used to implement a “secondary” (or, “coarse/grain”) routing layer that can “patch” these shortcomings in the socket's “primary” routing layer 310. In an implementation, the primary routing layer circuitry 311 essentially corresponds to the routing layer circuitry 211 discussed at length above: it is the routing function of the socket 310 to be used when the socket is running in normal operational circumstances.

However, according to the socket architecture of FIG. 3, a packet received by socket 310 is given to the secondary routing layer circuitry 320 if the primary routing layer 310 cannot route it (e.g., it is a debug or system maintenance packet, or, it has a destinationID that the primary routing layer has no entry for). The secondary routing layer circuitry 320 then performs a lookup that identifies the proper output port of the socket that the packet should be sent from in order to forward the debug packet toward its destination. Note that whether or not the packet is a debug packet or a system maintenance packet, or the destinationID/connectionID of a packet, can be determined by parsing or otherwise analyzing the header information of the packet.

According to one operational flow for a received packet, an initial attempt is made by the port that received the packet to have the packet routed by the primary routing layer 311. If the primary routing layer 311 cannot route the packet, the secondary routing layer 320 then attempts to route the packet. Thus, for instance, debug and/or system maintenance packets and packets having a destinationID (or perhaps connectionID) value that the primary routing layer 311 does not comprehend will be processed by the secondary routing layer circuitry 320. Note that the depiction of FIG. 3 indicates that the socket 310 can have as many as “X” ports 312_1 through 312_X.

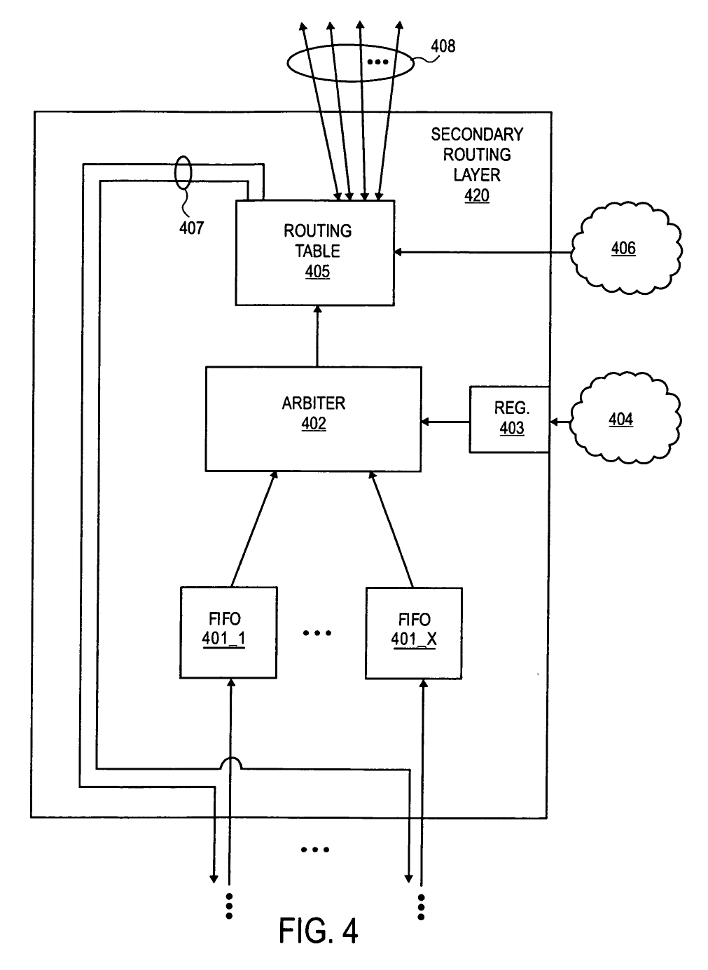

FIG. 4 shows a design 420 for the secondary routing layer circuitry 320 of FIG. 3. According to the design of FIG. 4, each port in the socket has a corresponding FIFO (e.g., FIFO 401_1 for port 312_1 and FIFO 401_X for port 312_X). When the port that received a packet realizes that the packet should be forwarded to the secondary routing layer 420 (e.g., because the primary routing layer refused to accept the packet), the packet is entered into its corresponding FIFO. Software running on the socket 404 may also decide to: 1) generate a debug or system maintenance packet; and/or 2) generate a packet whose destinationID (or connectionID) is not comprehended by the primary routing layer. If so, any such newly generated packets are entered into register 403.

Arbiter logic circuitry 402 implements a fairness algorithm (e.g., round robin) to determine which of the packets for whom an output port needs to be identified (i.e., any packet residing at the head of FIFOs 401_1 through the head of FIFO 401_X, and, a newly generated packet in register 403) will receive the benefit of a lookup operation performed upon lookup table 405. Lookup table 405 essentially corresponds to the secondary routing table and may be implemented with memory circuitry such as content addressable memory (CAM) circuitry. A system maintenance software thread 406 is also depicted to show that the content of the lookup table 405 is configurable.

A lookup operation essentially uses a packet's destinationID (or connectionID) as an input parameter and provides as an output parameter the output port that the packet should be transmitted upon. Once the output port for a packet is identified, the packet is forwarded to that output port (e.g., from one of FIFO's 401_1 though 401_X or from register 403). Paths 407 schematically indicate the identification of an output port from a lookup operation. Paths 408 is meant to show that packets whose destination corresponds to an internal component (e.g., a processor) within the secondary routing layer's own socket can be forwarded to the component after the lookup. Conceivably, such packets could be forwarded to the internal component before the lookup. In one implementation, received packets have a “forward enable” bit in their header information, and, a lookup operation for the packet is permitted only if this bit is activated.

According to one specific implementation, in order to support multicasting or broadcasting, the port that is identified by the lookup operation has associated information (e.g., kept within the lookup table) that identifies any other ports that the packet should be transmitted from. For instance, if X=4, the information may be kept as a 4 bit one-hot encoded vector where each bit represents a unique port. If a bit is activated, the packet should be forwarded to that port for transmission upon the port's corresponding link (e.g., 0011=packets should be sent from ports 3 and 4; 1100=packets should be sent from ports 1 and 2; 1111=pure broadcast from all ports).

According to a further implementation, the per entry parameter set maintained by the lookup table 405 within the secondary routing layer 420 is less comprehensive or detailed than the per entry parameter set maintained by the primary routing layer. Specifically, during normal operation the computing system's network comprehends multiple “virtual network” which reduce to multiple “channels” per link (e.g., one channel for system maintenance information, another channel for data transfers, etc.). As such, the primary routing layer not only identifies the proper port that an outbound packet should be transmitted from, but also identifies the proper virtual network that the packet should be transmitted on. By contrast, the secondary routing layer's routing table only identifies the proper output port.

Another feature of having a secondary routing layer is that debug and/or system maintenance packets can be sent across “partitions” that have been established within the computing system's network. Here, multi-processor computing systems that use networks are much more easily scaled upward than computing systems that use busses. That is, conceivably, “many” processors and memory controllers may be present within a single computing system. Partitioning is essentially an attempt to break down the computing system's network into a collection of smaller networks so that the computing system does not regularly attempt highly complicated/inefficient transactions.

For instance, a first mesh network that interconnects a first group or processors and a first memory controller may be established as a first partition, and, a second mesh network that interconnects a second group or processors and a second memory controller may be established as a second partition. Communications across partitions are possible, but, as a matter of normal course, most components within a partition engage in communications that are within their partition.

Nevertheless, it may be desirable to forward debug and/or system maintenance packets across partitions. Whereas, in the prior art, this was only possible for debug and/or system maintenance packets generated by sockets having a link that crossed into another partition (because, again, these types of packets are not comprehended by the prior art routing layer function), use of a secondary routing layer conceivably permits a debug and/or system maintenance packet generated by any socket to be transmitted across one or more partitions to any other socket—even if they have to traverse sockets that do not posses a link that is used to carry the packet across partitions.

The secondary routing layer discussed above can also be used as a secure, sideband control channel for system management and provisioning, and also can be used for virtualization enabling.

Note also that embodiments of the present description may be implemented not only within a semiconductor chip but also within machine readable media. For example, the designs discussed above may be stored upon and/or embedded within machine readable media associated with a design tool used for designing semiconductor devices. Examples include a circuit description formatted in the VHSIC Hardware Description Language (VHDL) language, Verilog language or SPICE language. Some circuit description examples include: a behavioral level description, a register transfer level (RTL) description, a gate level netlist and a transistor level netlist. Machine readable media may also include media having layout information such as a GDS-II file. Furthermore, netlist files or other machine readable media for semiconductor chip design may be used in a simulation environment to perform the methods of the teachings described above.

Thus, it is also to be understood that embodiments of this invention may be used as or to support a software program executed upon some form of processing core (such as the Central Processing Unit (CPU) of a computer) or otherwise implemented or realized upon or within a machine readable medium. A machine readable medium includes any mechanism for storing or transmitting information in a form readable by a machine (e.g., a computer). For example, a machine readable medium includes read only memory (ROM); random access memory (RAM); magnetic disk storage media; optical storage media; flash memory devices; etc.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. A method to be executed within a computing system having a network that couples a processor to a memory controller, said method comprising:
a) receiving a packet;
b) characterizing said packet as being of a type selected from the group consisting of:
i) a debug packet;
ii) a system maintenance packet;
iii) a packet having a destination identifier or connection identifier for which a primary routing table has no entry; and,
c) because said packet is of said type, using a secondary routing table to identify at least one output port upon which said packet is to be transmitted.

2. The method of claim 1 wherein said debug packet includes an event.

3. The method of claim 2 wherein said event is a trigger.

4. The method of claim 1 wherein said system maintenance packet describes an error.

5. The method of claim 1 further comprising referring to information maintained for said output port that indicates whether said packet is to be broadcasted.

6. The method of claim 1 further comprising referring to information maintained for said output port that indicates whether said packet is to be multicasted.

7. The method of claim 1 further comprising executing a fairness algorithm to determine that said packet is a next packet to have its said at least one output port determined, said packet selected over one or more other packets of said type.

8. The method of claim 7 wherein one of said one or more other packets is newly created.

9. A semiconductor chip, comprising:
two or more ports, each of said two or more ports comprising logic circuitry to process respective packets received from a respective link within a computing system having a network coupling a processor to a memory controller;
primary routing layer circuitry coupled to said two or more ports and comprising first memory circuitry to implement a primary routing table;
secondary routing layer circuitry coupled to said two or more ports and comprising second memory circuitry to implement a secondary routing table, said secondary routing table to contain entries for packets of a type selected from the group consisting of:
i) a debug packet;
ii) a system maintenance packet;
iii) a packet having a destination identifier or connection identifier for which said primary routing table has no entry.

10. The semiconductor chip of claim 9 wherein said secondary routing layer comprises a respective FIFO for each of said two or more ports.

11. The semiconductor chip of claim 10 wherein said secondary routing layer circuitry comprises arbiter logic circuitry to determine which of a plurality of packets of said type are to next have an output port identified.

12. The semiconductor chip pf claim 9 herein said secondary routing layer circuitry comprises a register to hold a newly created packet of said type.

13. A computing system, comprising:
a network coupling a processor to a memory controller;
two or more ports, each of said two or more ports comprising logic circuitry to process respective packets received from a respective copper based link within said network;
primary routing layer circuitry coupled to said two or more ports and comprising first memory circuitry to implement a primary routing table;
secondary routing layer circuitry coupled to said two or more ports and comprising second memory circuitry to implement a secondary routing table, said secondary routing table to contain entries for packets of a type selected from the group consisting of:
i) a debug packet;
ii) a system maintenance packet;
iii) a packet having a destination identifier or connection identifier for which said primary routing table has no entry.

14. The computing system of claim 13 wherein said secondary routing layer comprises a respective FIFO for each of said two or more ports.

15. The computing system of claim 14 wherein said secondary routing layer circuitry comprises arbiter logic circuitry to determine which of a plurality of packets of said type are to next have an output port identified.

16. The computing system of claim 13 herein said secondary routing layer circuitry comprises a register to hold a newly created packet of said type.
